(19) United States
(12) Patent Application Publication
(10) Pub. No.: US 2009/0268709 A1
(43) Pub. Date: Oct. 29, 2009

(54) TIME AND FREQUENCY CORRECTION FOR AN ACCESS POINT IN AN OFDMA COMMUNICATION SYSTEM

(75) Inventor: Xiaoyong YU, Grayslake, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/107,853

(22) Filed: Apr. 23, 2008

(51) Int. Cl. H04J 11/00

(52) U.S. Cl. 370/350; 375/260

(57) ABSTRACT

An apparatus and method for method for timing and frequency error correction in an access point. The method includes a first step (1200) of detecting embedded pilot signals in mobile station data traffic. A next step (1202) includes estimating a time error of the pilot signals by calculating a pilot signal phase difference across the tones in a tone index within the same OFDM symbol. A next step (1204) includes estimating a frequency error of the pilot signals by calculating a pilot signal phase difference across multiple OFDM symbols within a tone. A next step (1206) includes comparing of the estimated timing and frequency errors against a predefined threshold to determine if the access point needs to adjust its timing or frequency. A next step (1208) includes correcting the time and frequency error in the access point by using a symbol rotation of transmit data if at least one of the time and frequency errors exceed the threshold.

### CROSS-REFERENCE TO RELATED APPLICATION

This application is related to U.S. patent application Ser. No. ______ by inventors Yu, Kloos and Rottinghaus, filed concurrently with this application. The related application is assigned to the assignee of the present application, and is hereby incorporated herein in its entirety by this reference thereto.

### FIELD OF THE INVENTION

This invention relates to multiple wireless communication systems, in particular, to a mechanism for synchronization in an OFDMA wireless communication system.

### BACKGROUND OF THE INVENTION

The IEEE 802.16 communication standard, or WiMAX, uses an Orthogonal Frequency Division Multiple Access (OFDMA) protocol. In the OFDMA system, a mobile station (MS) is assigned a frequency sub-channel and a time slot in a physical layer for its communications with a base station, node B, or access point (AP). It is important in an OFDMA system to maintain both time and frequency synchronization. If frequency synchronization is lost between MSs and their serving AP, then orthogonality between the various sub-carriers is also lost, which results in interference, dropped calls, and poor network performance. If time error is present, system performance will be degraded due to received signal constellation rotation. Therefore, it is required in WiMAX that each AP maintains a time and frequency synchronization suitable to properly serve the most MSs as possible.

It is well-known that channel estimate, timing and frequency synchronization are three critical components in any receiver. In a WiMAX AP, while traditional prior art OFDM channel estimate methods can be directly applied, timing and frequency synchronization need special consideration due to the Time Division Duplex (TDD) and OFDMA operations. In OFDMA system, all mobile users share the same frequency and time resources and each of them has its own timing and frequency error. However, traditional timing and frequency error correction techniques operated in time domain are not applicable in this case.

In particular, the prior art focus is on OFDM point-to-point (not OFDMA) communications, and does not deal with processing for multiple users, and can not do per user corrections or per burst corrections due to time domain based implementations. In addition, the prior art typically provides timing/frequency error estimates in the time domain or use special training signals or based on Cyclic Prefix (CP).

Accordingly, what is needed is a technique to timing and frequency correction of an AP so as to benefit the most MSs being served by the AP. This should be accomplished without significant computation loading increase in AP.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 shows an overview block diagram of a wireless communication system supporting OFDMA, in accordance with the present invention;

FIG. 2 shows a block diagram of the receiver of FIG. 1;

FIG. 3 shows a graphical representation, for different communication devices, of synchronization errors that can presently exist in a WiMAX communication system;

FIG. 4 shows a graphical representation of a first embodiment of pilot and data signals in an OFDMA communication system, in accordance with the present invention;

FIG. 5 shows a graphical representation of a second embodiment of pilot and data signals in an OFDMA communication system, in accordance with the present invention;

FIG. 6 shows a graphical representation of an example of linear interpolation for FIG. 5;

FIG. 7 shows a graphical representation of an example of extrapolation for FIG. 5;

FIG. 8 illustrates simulation results showing an estimated timing error averaged over 1000 trials, in accordance with the present invention;

FIG. 9 illustrates simulation results showing an estimated frequency error averaged over 1000 trials, in accordance with the present invention;

FIG. 10 illustrates simulation results without timing or frequency offsets;

FIG. 11 illustrates simulation results with timing or frequency offsets, in accordance with the present invention;

FIG. 12 is a flow chart illustrating a method, in accordance with the present invention.

Skilled artisans will appreciate that common but well-understood elements that are useful or necessary in a commercially feasible embodiment are typically not depicted or described in order to facilitate a less obstructed view of these various embodiments of the present invention.

### DESCRIPTION OF THE PREFERRED EMBODIMENTS

The present invention provides a framework wherein time and frequency error correction of an AP is provided so as to benefit the most MSs being served by the AP. The timing and frequency synchronization of each MS may also vary, and the minor time and frequency error correction of an AP in the present invention may not address an MS that is too far out of synchronization. Therefore, the present invention is a sub-optimal solution for AP/MS synchronization, and MS synchronization to the AP can be addressed separately to provide an optimum solution. As described herein, the present invention addresses only a minor time and frequency error correction of an AP so as to provide an average time/frequency baseline that serves the most MSs that have not yet undergone any further time/frequency synchronization correction.

Specifically, the present invention provides a framework wherein timing and frequency error correction is achieved by using data traffic. For different signal structures, i.e. Partial Usage of Subchannels (PUSC) or Band Adaptive Modulation and Coding (AMC), post-FFT pilot-based timing and frequency errors are estimated by calculation of pilot signal phase ramp across a time dimension (e.g. OFMD symbol index) and a frequency dimension (e.g. tone index) respectively based on embedded pilot signals. This is accomplished without a significant increase in computation loading.

In particular, the present invention provides a computationally efficient method for calculating and applying simultaneous corrections for timing error, frequency error, and channel estimate based on embedded pilot signals in a WiMAX transmission, whereas any traditional methods are much more costly in terms of processing power for calculating and applying all of these corrections. The present invention produces sub-optimal estimate which meets performance requirements while at the same time reducing computational complexity. The present invention introduces an algorithm, applied on a per-user and per-burst basis, which leverages the relationship between timing and frequency errors in the time and/or frequency domains, and produces a blind composite estimate for time correction, frequency correction, and channel estimation. Moreover, the solution provided is able to combine Automatic Timing Correction (ATC), Automatic Frequency Correction (AFC), and channel estimate into one.

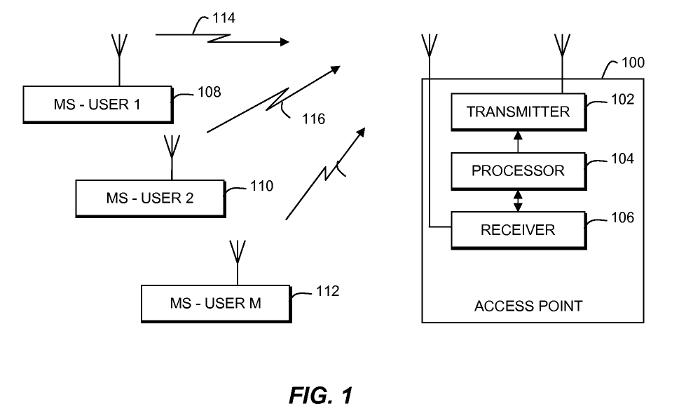

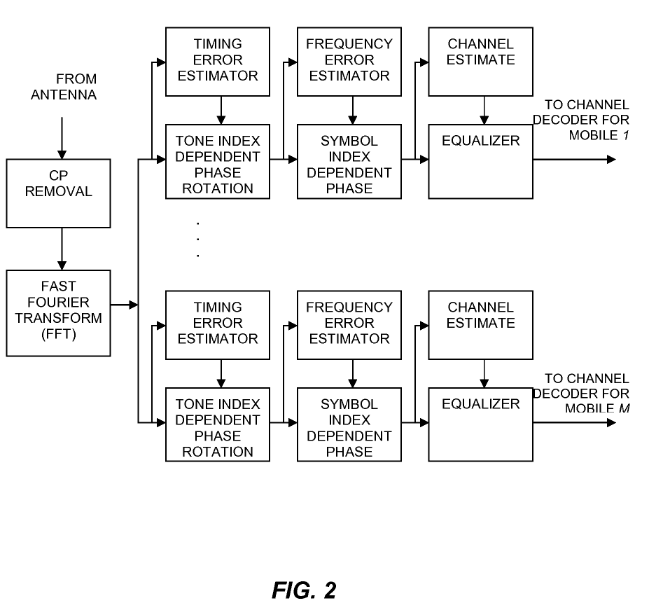

FIG. 1 is a block diagram depiction of an OFDMA wireless communication system, such as the IEEE 802.16 WiMAX system, in accordance with the present invention. At present, standards bodies such as OMA (Open Mobile Alliance), 3GPP (3rd Generation Partnership Project), 3GPP2 (3rd Generation Partnership Project 2) and IEEE (Institute of Electrical and Electronics Engineers) 802 are developing standards specifications for such wireless telecommunications systems. The communication system represents a system operable in a packet data access network that may be based on different wireless technologies. For example, the description that follows will assume that the access network is IEEE 802.XX-based, employing wireless technologies such as IEEE's 802.11, 802.16, or 802.20. Being 802.XX-based, the system is modified to implement embodiments of the present invention. Although the present invention is described herein in terms of a Long Term Evolution (LTE) embodiment, applied between a first and second Fast Fourier Transform (FFT) function of an AP receiver 106, as shown in FIG. 2, it should be recognized that the present invention has further application in any OFDMA protocol.

Referring to FIG. 1, there is shown a block diagram of an access point 100 adapted to support the inventive concepts of the preferred embodiments of the present invention. Those skilled in the art will recognize that FIG. 1 does not depict all of the network equipment necessary for system to operate but only those system components and logical entities particularly relevant to the description of embodiments herein. For example, an access point (AP) or base station can comprise one or more devices such as wireless area network stations (which include access nodes (ANs), AP controllers, and/or switches), base transceiver stations (BTSs), base site controllers (BSCs) (which include selection and distribution units (SDUs)), packet control functions (PCFs), packet control units (PCUs), and/or radio network controllers (RNCs). However, none of these other devices are specifically shown in FIG. 1.

Instead, AP 100 is depicted in FIG. 1 as comprising a processor 104 coupled to a transceiver, such as receiver 106 and transmitter 102. In general, components such as processors and transceivers are well-known. For example, AP processing units are known to comprise basic components such as, but not limited to, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using messaging flow diagrams, and/or expressed using logic flow diagrams.

Thus, given an algorithm, a logic flow, a messaging/signaling flow, and/or a protocol specification, those skilled in the art are aware of the many design and development techniques available to implement an AP processor that performs the given logic. Therefore, AP 100 represents a known apparatus that has been adapted, in accordance with the description herein, to implement various embodiments of the present invention. Furthermore, those skilled in the art will recognize that aspects of the present invention may be implemented in and across various physical components and none are necessarily limited to single platform implementations. For example, the AP aspect of the present invention may be implemented in any of the devices listed above or distributed across such components. Furthermore, the various components within the AP 100 can be realised in discrete or integrated component form, with an ultimate structure therefore being merely based on general design considerations. It is within the contemplation of the invention that the operating requirements of the present invention can be implemented in software, firmware or hardware, with the function being implemented in a software processor 104 (or a digital signal processor (DSP)) being merely a preferred option.

AP 100 uses a wireless interface for communication with one or more mobile stations, MS-USER 1 108, MS-USER 2 110 . . . MS-USER M 112. Since, for the purpose of illustration, AP 100 is IEEE 802.16-based, wireless interfaces correspond to a forward link and a reverse link, respectively, each link comprising a group of IEEE 802.16-based channels and subchannels used in the implementation of various embodiments of the present invention.

Mobile stations (MS) or remote unit platforms are known to refer to a wide variety of consumer electronic platforms such as, but not limited to, mobile nodes (MNs), access terminals (ATs), terminal equipment, gaming devices, personal computers, and personal digital assistants (PDAs). In particular, each MS 108, 110, 112 comprises a processor coupled to a transceiver, antenna, a keypad, a speaker, a microphone, and a display, as are known in the art and therefore not shown.

Mobile stations are known to comprise basic components such as, but not limited to, microprocessors, digital signal processors (DSPs), microcontrollers, memory devices, application-specific integrated circuits (ASICs), and/or logic circuitry. Such mobile stations are typically adapted to implement algorithms and/or protocols that have been expressed using high-level design languages or descriptions, expressed using computer instructions, expressed using messaging/signaling flow diagrams, and/or expressed using logic flow diagrams. Thus, given an algorithm, a logic flow, a messaging/signaling flow, a call flow, and/or a protocol specification, those skilled in the art are aware of the many design and development techniques available to implement user equipment that performs the given logic.

Each mobile station 108, 110, 112 provides respectively uplink signals 114, 116, 118 to the receiver 106 of the AP 100. Each of these uplink signals may present different time and frequency errors due to MS environmental changes, mobility, timing drift, etc. As these uplink signals 114, 116, 118 may all be transmitted on the same frequency sub-channel, they are not separable by the processor 104 of the AP 100. In accordance with IEEE 802.16, the uplink signals consist of a Cyclic Prefix (CP) followed by an N-sample block output from the Inverse Fast Fourier Transform (IFFT) of the MS processor.

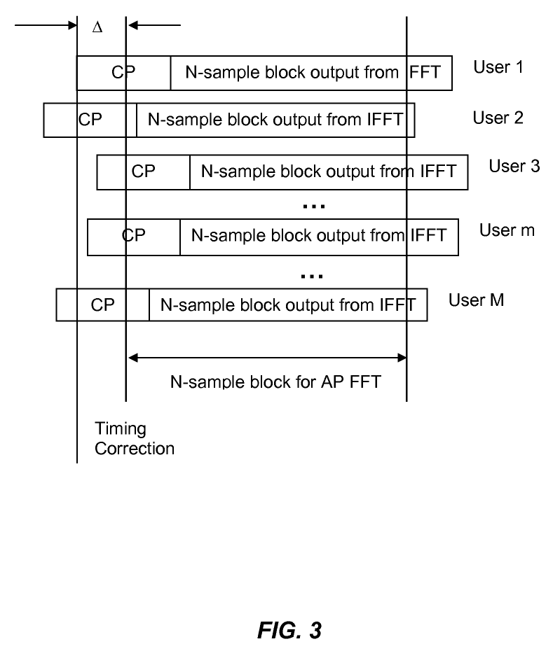

FIG. 3 illustrates the aggregate uplink timing errors for uplink signals for various mobile stations, wherein each MS's signal arrives at the AP with a different timing error. After initial ranging, and during regular data communication, it is reasonable to assume that the UL timing error is within the CP length and the frequency error is less than 2% of tone spacing (per WiMAX). The role of periodic ranging is to monitor/update timing and frequency offset due to environmental changes of each MS. Based on measured timing and frequency error, the AP could instruct each MS to adjust its transmit time and frequency accordingly. However, periodic ranging may not be available, as previously described above.

In accordance with the present invention, at the AP receiver, CP is removed by taking N samples of the received aggregate signal, where N is FFT size of the system. The N samples are taken by a fixed offset Δ from reference time to compensate various channel delays and transmit time error of each mobile user. It is easy to remove all impacts introduced by this known Δ offset in AP receiver. The present invention provides a timing error correction for residual timing error that is beyond the fixed offset Δ, together with frequency error correction and channel equalization.

It is beneficial at this point to first understand the impact of timing and frequency error on a received OFDMA signal. Let τ be the timing error of mobile m, where τ=Δ+τₘ that includes known offset Δ and residual error τₘ of the mobile. We can then write the nth baseband sample in an OFDM symbol as

rₙ=s_{n+τ}e^{jφ}

where x_{n+τ} is the time-shifted baseband signal transmitted from the mobile m, and φ is the related phase offset due to the timing error τ. If the timing error magnitude is less than the CP length, due to the cyclic property of OFDM symbols, the data symbol on the kth tone after an N-point FFT is given as

$$\begin{matrix}{\tilde{s}}_{k} = \frac{1}{\sqrt{N}} {\sum }_{n = 0}^{N - 1} {r}_{n} {e}^{- j2π \frac{k}{N} n} \\ = \frac{1}{N} {\sum }_{n = 0}^{N - 1} [ {e}^{jφ} {\sum }_{i = 0}^{N - 1} {s}_{i} {e}^{j2π \frac{n + τ}{N} i} ] {e}^{- j2π \frac{k}{N} n} \\ = \{ \begin{matrix}{e}^{jφ} {s}_{k} {e}^{j2π \frac{τ}{N} k} & if i = k \\ 0 & otherwise\end{matrix}\end{matrix}$$

Where sₖ is the transmitted data symbol of mobile m on the kth tone. Clearly, the timing error only causes a phase shift on received data symbols, providing the error magnitude is smaller than CP length. For each individual tone, the phase shift is a linear function of the tone index k. Consequently, timing error correction for mobile m becomes a phase rotation depending on tone index k and timing error τ that is less than a CP length.

Next, assuming a received signal has a frequency error Δf in fraction of sampling frequency, (without a loss of generality, we assume zero initial phase for simplicity), the discrete samples can be expressed as

rₙ=xₙe^{j2πΔfn}

One OFDM symbol consists of (N+N_{CP}) samples, where N_{CP} represents the number of samples in the CP, the kth tone of the pth OFDM after N-point FFT can be written as:

$$\begin{matrix}{\tilde{s}}_{k} ( p ) = \frac{1}{\sqrt{N}} {\sum }_{n = 0}^{N - 1} {r}_{n + ( p - 1 ) N + {pN}_{CP}} {e}^{- j2π \frac{k}{N} n} \\ = \frac{1}{N} {\sum }_{n = 0}^{N - 1} [ {\sum }_{i = 0}^{N - 1} {s}_{i} ( p ) {e}^{j2π \frac{n}{N} i} ] {e}^{j2πΔ f ( n + ( p - 1 ) N + {pN}_{CP} )} {e}^{- j2π \frac{k}{N} n} \\ \approx {e}^{jΦ ( p )} {s}_{k} ( p ) + {e}^{jΦ ( p )} \frac{1}{N} {\sum }_{i = 0 , i \neq k}^{N - 1} {s}_{i} ( p ) {\sum }_{n = 0}^{N - 1} {e}^{j2π \frac{n}{N} ( i - k )} {e}^{j2πΔ fn}\end{matrix}$$

where Φ(p)=2πΔf((p−1)N+pN_{CP}) is a phase due to frequency error Δf for OFDM symbol p. This phase is common to all tones within a particular OFDM symbol. The second term of the above equation represents Inter-Carrier Interference (ICI) from other tones. It should be noted that the approximation is based on the fact that

e^{j2πΔfk}≈1 for very small Δf

Therefore, the impact of frequency error is a common phase rotation for all tones in an OFDM symbol plus ICI from other tones. While the phase rotation can be easily corrected, the ICI due to frequency error can not be removed by a simple one-tap equalizer. We must live with the ICI and strive to limit the frequency error (for example, within 2% of tone spacing). Consequently, for small amount of frequency error, the frequency error correction for mobile m becomes a phase rotation that is a linear function of time or OFDM symbol index, and Δf.

Based on above analysis, the timing and frequency synchronization of OFDMA system is equivalent to estimate of timing error τ and frequency error Δf for each mobile m. This can only be implemented after FFT in receiver, where each mobile signal can be separated. It should be noted that traditional timing and frequency error estimates operated in time domain or before FFT is not applicable to OFDMA receiver, where individual mobile's signal is not separable.

There are two UL signal structures in WiMAX, namely Partial Usage of Subchannels (PUSC) or Band Adaptive Modulation and Coding (AMC). Depending on the PUSC or AMC mode, the associated timing and frequency error estimate for each signal structure is presented separately in two embodiments of the present invention described in detail below.

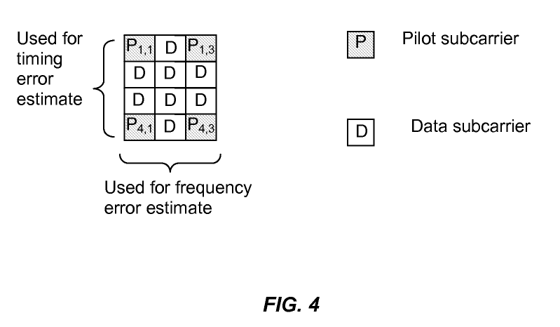

FIG. 4 represents a first embodiment of the present invention of a PUSC implementation and shows a PUSC tile structure and a pair of pilot signals used for timing and frequency error estimates. Each pilot signal in a tile is identified by a pair of indices (k, n), with k=1 or 4 and n=1 or 3, e.g. P_{1,3}(t) means the pilot signal is on the first tone and third OFDM symbol of tile t.

The timing and frequency error of mobile station m can be calculated as

$${τ}_{m} = \frac{N \times {Φ}_{m}}{6 π} - Δ and Δ {f}_{m} = \frac{{Ω}_{m}}{4 π \times {T}_{S}}$$

where T_{S} is OFDM symbol interval including CP,

$${Φ}_{m} = angle ( \frac{1}{T} {\sum }_{t = 1}^{T} ( {P}_{4 , 1} ( t ) {P}_{1 , 1}^{*} ( t ) + {P}_{4 , 3} ( t ) {P}_{1 , 3}^{*} ( t ) ) )$$

$$and$$

$${Ω}_{m} = angle ( \frac{1}{T} {\sum }_{t = 1}^{T} ( {P}_{1 , 1}^{*} ( t ) {P}_{1 , 3} ( t ) + {P}_{4 , 1}^{*} ( t ) {P}_{4 , 3} ( t ) ) )$$

where T is number of total tiles assigned to mobile station m.

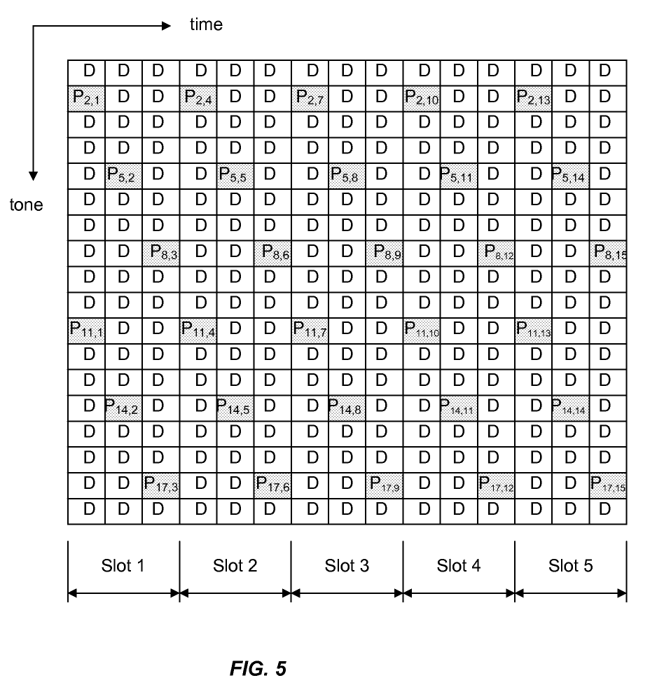

FIG. 5 represents a second embodiment of the present invention of an AMC implementation and shows a 2×3 AMC signal structure, which is one sub-channel consisting of a number (five in this example) of consecutive slots in time to form a stripe. Each slot has eighteen tones across three OFDM symbols. Similarly, the timing and frequency error of mobile m can be determined as

$${τ}_{m} = \frac{N \times {Φ}_{m}}{18 π} - Δ and Δ {f}_{m} = \frac{{Ω}_{m}}{6 π \times {T}_{S}}$$

where T_{S} is OFDM symbol interval including CP,

$${Φ}_{m} = angle ( \frac{1}{S} {\sum }_{s = 1}^{S} ( {P}_{11 , 1} ( s ) {P}_{2 , 1}^{*} ( s ) + {P}_{14 , 2} ( s ) {P}_{5 , 2}^{*} ( s ) + {P}_{17 , 3} ( s ) {P}_{8 , 3}^{*} ( s ) ) )$$

here S is number of total slots in a sub-channel assigned to mobile station m, s is slot index, e.g., P_{14,2}(3) means the pilot in 14^{th} tone of 2^{nd} OFDM symbol in slot 3; and

$${Ω}_{m} = angle \{ \frac{1}{6 ( S - 1 )} [ {\sum }_{k = 1}^{3} {\sum }_{s = 1}^{S - 1} ( \begin{matrix}{P}_{3 ( k - 1 ) + 2 , 3 ( s - 1 ) + k}^{*} {P}_{3 ( k - 1 ) + 2 , 3 s + k} + \\ {P}_{3 ( k - 1 ) + 11 , 3 ( s - 1 ) + k}^{*} {P}_{3 ( k - 1 ) + 11 , 3 s + k}\end{matrix} ) ] \}$$

where S is number of total slots in a sub-channel assigned to mobile station m, the subscript of pilot represents relative tone index within a slot and OFDM symbol index of all assigned slots respectively, e.g., for k=2, s=3, the P_{3(k-1)-k,3s+k}=P_{5,11} that is the pilot in the 5^{th} tone of 11^{th} OFDM symbol for all assigned slots (or the 5^{th} tone of 2^{nd} OFDM in slot 4). If the mobile station has multiple sub-channels, Φₘ and Ωₘ should be averaged over all sub-channels.

Referring back to FIG. 2, once the timing and frequency errors for each mobile have been calculated, an associated phase rotation is applied to each received data for correction, as shown. The correction operation is obvious, for example, if the estimated timing error is τₘ for mobile m, the associated timing error correction is given

$${X}_{k} = {\tilde{S}}_{k} {e}^{- j2π \frac{Δ + {τ}_{m}}{N} k}$$

where \tilde{S}ₖ is the signal on the kth tone of an OFDM symbol after N-point FFT. Similarly, the frequency error correction can be expressed as

Yₖ(p)=Xₖ(p)e^{j2πΔf}^{ₘ}^{((p 1)N|pN}^{_{Cp}}⁾

where Xₖ(p) is the timing error corrected signal on the kth tone of pth OFDM symbol and Δfₘ is estimated frequency error in fraction of sampling frequency associated with mobile m. It should be noted that the values applied to timing and frequency correction are those estimates averaged or low-pass filtered over a number of frames for better results in fading cases.

To reduce computational complexity and latency, it is possible to combine timing error, frequency error and channel estimate together and correct them in the equalizer. In this case, the timing error and frequency error estimate are based on one observation of received pilots. For example, in case of AMC 2×3, we can achieve channel estimate, timing error estimate and frequency error estimate by two times of 1-D linear interpolation.

The basic idea of two times 1-D linear interpolation is to perform two sets of interpolations: one horizontally across time index (for frequency error estimate) and the other interpolation vertically across tone index (for timing error estimate) in a subchannel, in addition to extrapolations and nearest data grid fitting. For example, considering the data structure in FIG. 5, each data position can be labelled by a pair of indexes (k, j), where k represents tone and j indicates OFDM symbol. Therefore, k=1, 2, 3, . . . , 18 and j=1, 2, 3, . . . , 15 in the example. For instance, H_{2,3} denotes channel estimate of data position of the 2^{nd} tone (from top to bottom) in 3^{rd} OFDM symbol (from left to right). Consequently, the channel estimate together with timing/frequency error estimate of 2×3 AMC in a time stripe is performed in the following steps:

First, determine the least-squared channel estimate (LS CE) at each pilot positions (i.e. data positions where pilot symbols are present) by dividing each known pilot value into corresponding received pilot symbol, i.e., H_{k,j}=P_{k,j}/\hat{P}_{k,j}, where P_{k,j} is received pilot symbol and \hat{P}_{k,j} represents correspondent known value at pilot position (k,j).

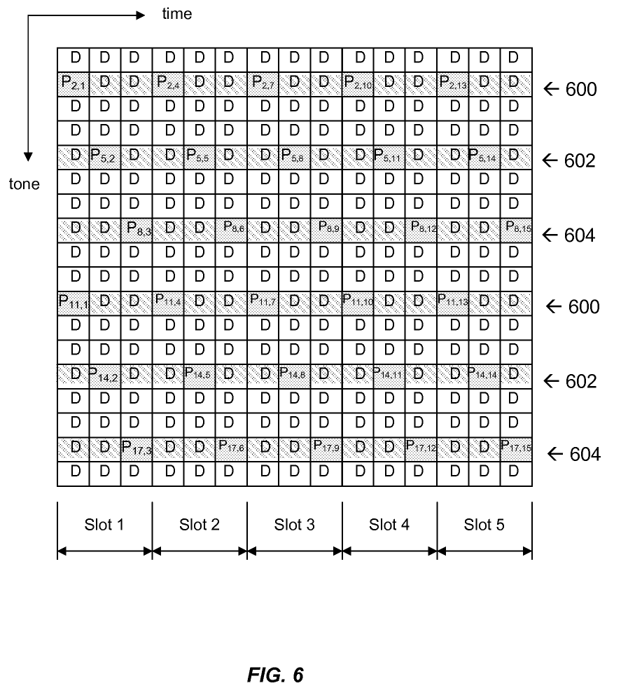

Second, calculate first set of 1-D linear interpolation horizontally across OFDM symbols within the same tone as shown in FIG. 6, where lines 600-604 indicate the 1-D linear interpolation within a bin. Clearly, each interpolated CE is a linear combination of its two adjacent pilots, with coefficient ⅓ and ⅔. For example

$${H}_{2 , 2} = \frac{2}{3} {H}_{2 , 1} + \frac{1}{3} {H}_{2 , 4}$$

in line 600 and

$${H}_{8 , 5} = \frac{1}{3} {H}_{8 , 3} + \frac{2}{3} {H}_{8 , 6}$$

in line 604 within the first bin.

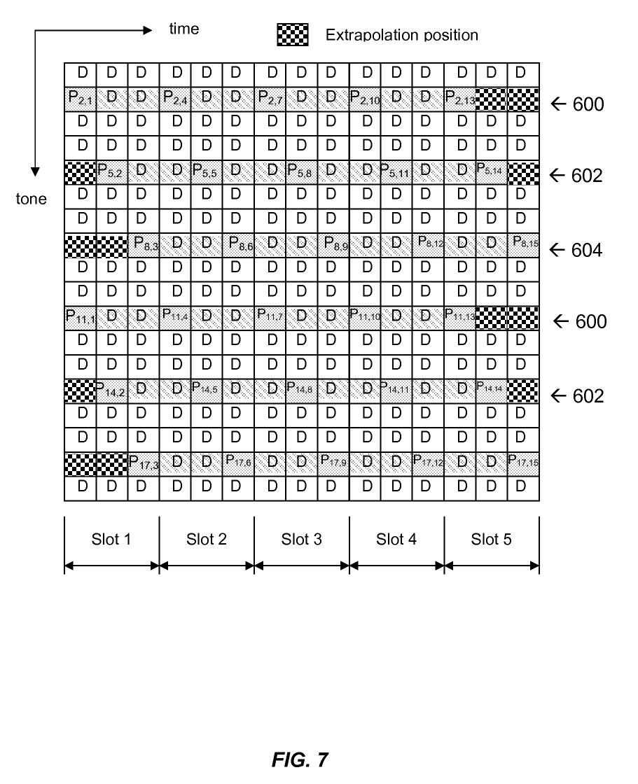

Third, perform some extrapolations at some points where there is no pilot signal (i.e. those data positions that are not covered by any pilot within the same tone) to complete the first set of 1-D interpolation for those data positions outside of pilots in lines 600, 602, 604, respectively, as shown in FIG. 7. For example, CE of two data positions in lines 600 of the first bin is given as

$${H}_{2 , 14} = \frac{2}{3} {H}_{2 , 13} + \frac{1}{3} {H}_{5 , 14} and {H}_{2 , 15} = \frac{2}{3} {H}_{2 , 13} + \frac{1}{6} {H}_{5 , 14} + \frac{1}{6} {H}_{8 , 15} .$$

CE of two data positions in lines 602 of the first bin is determined as

$${H}_{5 , 1} = \frac{1}{3} {H}_{2 , 1} + \frac{2}{3} {H}_{5 , 2} and {H}_{5 , 15} = \frac{1}{3} {H}_{8 , 15} + \frac{2}{3} {H}_{5 , 14} .$$

Finally CE of two data positions in lines 604 of the first bin computed as

$${H}_{8 , 2} = \frac{1}{3} {H}_{5 , 2} + \frac{2}{3} {H}_{8 , 3} and {H}_{8 , 1} = \frac{1}{3} {H}_{8 , 3} + \frac{1}{3} {H}_{11 , 1} + \frac{1}{6} {H}_{2 , 1} + \frac{1}{6} {H}_{5 , 2} .$$

For the second bin, similar extrapolations are calculated for the rest of six data positions as follows:

$${H}_{11 , 14} = \frac{2}{3} {H}_{11 , 13} + \frac{1}{3} {H}_{14 , 14}$$

$${H}_{11 , 15} = \frac{1}{3} {H}_{11 , 13} + \frac{1}{3} {H}_{8 , 15} + \frac{1}{6} {H}_{14 , 14} + \frac{1}{6} {H}_{17 , 15}$$

$${H}_{14 , 1} = \frac{1}{3} {H}_{11 , 1} + \frac{2}{3} {H}_{14 , 2}$$

$${H}_{14 , 15} = \frac{1}{3} {H}_{17 , 15} + \frac{2}{3} {H}_{14 , 14}$$

$${H}_{17 , 1} = \frac{2}{3} {H}_{17 , 3} + \frac{1}{6} {H}_{11 , 1} + \frac{1}{6} {H}_{14 , 2}$$

$${H}_{17 , 2} = \frac{1}{3} {H}_{14 , 2} + \frac{2}{3} {H}_{17 , 3}$$

Fourth, compute a second set of 1-D linear interpolations vertically across all tones of a tone index within the same OFDM symbol that is assigned to the same user for data positions with tone index 2≦k≦17, where either pilots or data positions interpolated/extrapolated in the third step served as known values. That is, all positions within lines 600-604 have determined CEs that are used as known values in the second set of 1-D linear interpolations. Clearly, the linear interpolation coefficients here are the same as those in the first set of 1-D interpolations, they are either ⅓ or ⅔. For instance,

$${H}_{3 , 1} = \frac{2}{3} {H}_{2 , 1} + \frac{1}{3} {H}_{5 , 1} and {H}_{4 , 1} = \frac{1}{3} {H}_{2 , 1} + \frac{2}{3} {H}_{5 , 1} .$$

Fifth, approximate CE of the first tone and last tone by nearest data grid fitting for the remaining points. The CE of first tone is the same as that of second tone, across all OFDM symbols assigned to the same user, and the CE of last tone is the same as that of the second tone from the last, across all OFDM symbols assigned to the same user. That is, CE of the first tone is the same as second tone and CE of the last tone is identical to the seventeenth tone. Mathematically, H_{1,j}=H_{2,j} and H_{18,j}=H_{17,j} for j=1, 2, 3, . . . , 15.

For the PUSC mode, the combination of channel estimate, timing and frequency error correction within a tile is simple, where there is no need for extrapolation and nearest data grid fitting. For example, the first set of 1-D (horizontal) linear interpolation is average of two pilots, i.e., H_{1,2}=0.5(H_{1,1}+H_{1,3}) and H_{4,2}=0.5(H_{4,1}+H_{4,3}), where H_{1,1}, H_{1,3}, H_{4,1} and H_{4,3} are LS CE at pilot positions. The second set of 1-D (vertical) linear interpolation is obvious, particularly where the composite CE of data positions in a tile is given as

$${H}_{2 , n} = \frac{2}{3} {H}_{1 , n} + \frac{1}{3} {H}_{4 , n} and {H}_{3 , n} = \frac{2}{3} {H}_{4 , n} + \frac{1}{3} {H}_{1 , n} ,$$

where n denotes OFDM symbol index within a tile, clearly n=1, 2 or 3 for PUSC mode. The LS CE is firstly calculated at each corner of a tile. The composite CE of the data position in the first and last tone of a tile is the average of two pilot signals that are in the same tone, respectively.

### EXAMPLE

To evaluate performance of proposed method for PUSC, simulations have been conducted, where three mobiles each has a timing offset of −50, 10 and 60 samples respectively and a frequency offset 2%, −2% and 1% of tone spacing respectively. In the case of a 10 MHz WiMAX system, the frequency offset is equal to 218.75 Hz, −218.75 Hz and 109.375 Hz respectively. The three mobiles were multiplexed and transmitted over five channels, i.e., AWGN, Rician, PB3, TU50 and VA60, as are known in the art.

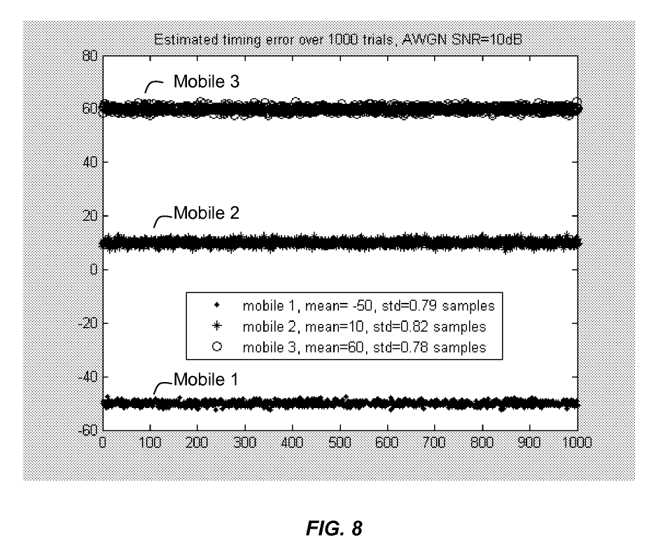

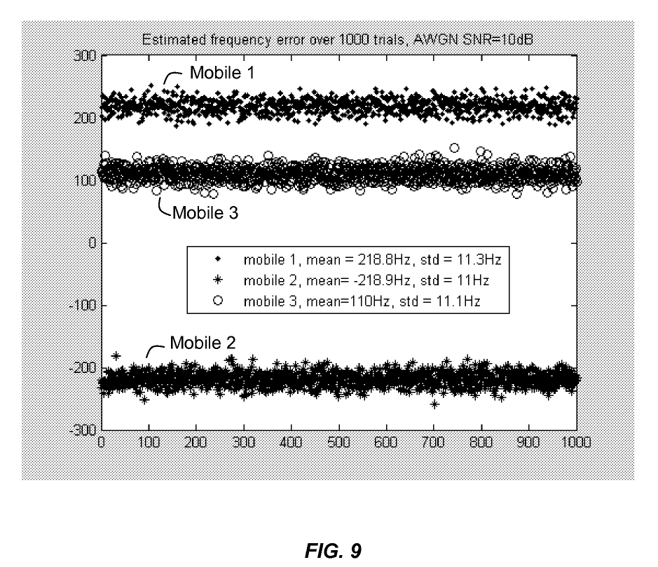

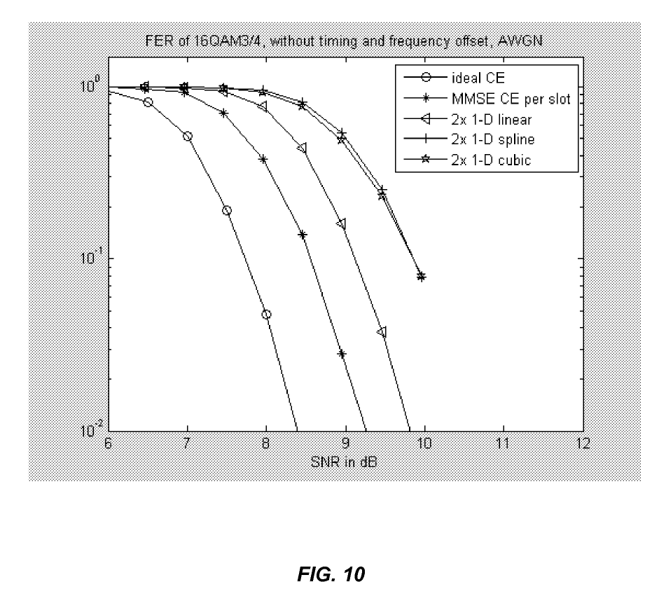

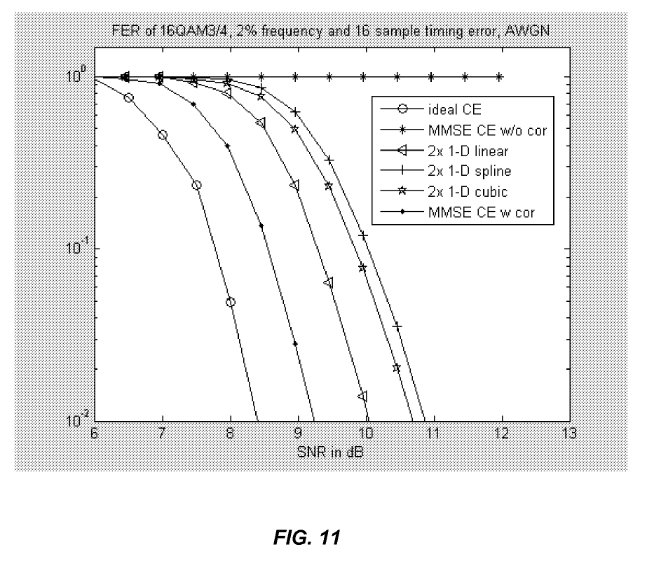

FIGS. 8-11 show the simulation results. Based on the results, we see the proposed method works well. It should be noted that WiMAX currently allows ±1% of tone spacing frequency error, but in the present invention the AP can tolerate up to ±5% of tone spacing frequency error. AMC 2×3 will also work well inasmuch as AMX2×3 has a slightly lower pilot density which could degrade performance, but this is mitigated by the pilot signal boosting of 2.5 dB in AMC and the fact that channel estimation should be better due to the contiguous nature of the subcarriers. FIG. 8 shows estimated timing error averaged over 1000 trials for the AWGN case. FIG. 9 shows the frequency offset estimate versus Signal-to-Noise Ratio for three users in the AWGN case. FIGS. 10 and 11 show Frame Error Rate (FER) of 16QAM3/4 CTC, with two Rx antennas, under AWGN with and without frequency and timing offset respectively. In case of perfect timing and zero frequency offset, traditional minimum mean squared error (MMSE) channel estimate results in the best practical performance. However, this traditional MMSE channel estimate fails completely when frequency and timing offset is introduced. Only when timing and frequency error correction method per the invention is applied, can MMSE CE outperform prior art channel estimate methods. It should be noted that the proposed two times 1-D linear interpolation is the simplest and robust one, which implicitly corrects timing and frequency error during channel estimate.

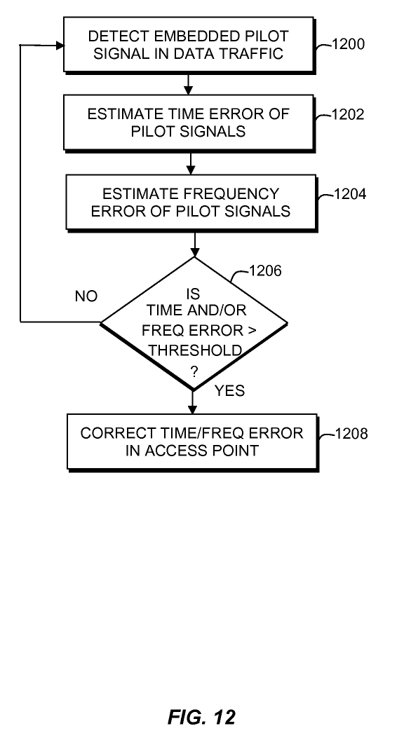

FIG. 12 shows a flowchart that illustrates a method for timing and frequency error correction in an access point of an OFDMA communication system, in accordance with the present invention. A first step 1200 includes detecting embedded pilot signals in mobile station data traffic, where the Cyclic Prefix has been removed from the data traffic and the signal has been FFT transformed.

A next step 1202 includes estimating a time error of the pilot signals by calculating a pilot signal phase difference across the tones in a tone index within the same OFDM symbol.

A next step 1204 includes estimating a frequency error of the pilot signals by calculating a pilot signal phase difference across multiple OFDM symbols within a tone.

A next step 1206 includes comparing of the estimated timing and frequency errors against a predefined threshold to determine if the access point needs to adjust its timing or frequency.

A next step 1208 includes correcting the time and frequency error in the access point by using a symbol rotation of transmit data if at least one of the time and frequency error exceed the threshold.

Advantageously, the present invention provides post-FFT pilot-based timing and frequency error correction for PUSC and AMC modes in a WiMAX communication system.

Although the preferred embodiment of the present invention is described with reference to base stations in a WiMAX wireless communication system, it will be appreciated that the inventive concepts hereinbefore described are equally applicable to any OFDMA wireless communication system where synchronization of communication units is an issue.

It will be understood that the terms and expressions used herein have the ordinary meaning as is accorded to such terms and expressions by persons skilled in the field of the invention as set forth above except where specific meanings have otherwise been set forth herein.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for time and frequency error correction in an access point of an OFDMA communication system, the method comprising the step of:
detecting embedded pilot signals in mobile station data traffic;
estimating a time error by calculating a pilot signal phase difference across a tone index within the same OFDM symbol;
estimating a frequency error by calculating a pilot signal phase difference across multiple OFDM symbols within a tone; and
correcting the time and frequency errors in the access point by using a symbol rotation of transmit data.

2. The method of claim 1, wherein the detecting step includes removing the Cyclic Prefix from the data traffic and performing FFT.

3. The method of claim 1, wherein the communication system is a WiMAX system in a Partial Usage of Sub-channels tile structure implementation, and wherein the detecting step identifies each pilot signal in a tile by a pair of indices (k, n), with k=1 or 4 and n=1 or 3.

4. The method of claim 3, wherein the time error in the estimating a time error step is
$${τ}_{m} = \frac{N \times {Φ}_{m}}{6 π} - Δ , where {Φ}_{m} = angle ( \frac{1}{T} {\sum }_{t = 1}^{T} ( {P}_{4 , 1} ( t ) {P}_{1 , 1}^{*} ( t ) + {P}_{4 , 3} ( t ) {P}_{1 , 3}^{*} ( t ) ) )$$
and T is number of total tiles assigned to mobile station m.

5. The method of claim 3, wherein the frequency error in the estimating a frequency error step is
$$Δ {f}_{m} = \frac{{Ω}_{m}}{4 π \times {T}_{S}} ,$$
where T_{S} is OFDM symbol interval including Cyclic Prefix,
$${Ω}_{m} = angle ( \frac{1}{T} {\sum }_{t = 1}^{T} ( {P}_{1 , 1}^{*} ( t ) {P}_{1 , 3} ( t ) + {P}_{4 , 1}^{*} ( t ) {P}_{4 , 3} ( t ) ) ) ,$$
and T is number of total tiles assigned to mobile station m.

6. The method of claim 1, wherein the communication system is a WiMAX system in a Adaptive Modulation and Coding implementation, and wherein the time error in the estimating a time error step is
$${τ}_{m} = \frac{N \times {Φ}_{m}}{18 π} - Δ ,$$
where
$${Φ}_{m} = angle ( \frac{1}{S} {\sum }_{s = 1}^{S} ( {P}_{11 , 1} ( s ) {P}_{2 , 1}^{*} ( s ) + {P}_{14 , 2} ( s ) {P}_{5 , 2}^{*} ( s ) + {P}_{17 , 3} ( s ) {P}_{8 , 3}^{*} ( s ) ) ) ,$$
and S is number of total slots in a sub-channel assigned to mobile station m, s is slot index.

7. The method of claim 1, wherein the communication system is a WiMAX system in a Adaptive Modulation and Coding implementation, and wherein the frequency error in the estimating a frequency error step is
$$Δ {f}_{m} = \frac{{Ω}_{m}}{6 π \times {T}_{S}} ,$$
where T_{S} is OFDM symbol interval including Cyclic Prefix, and
$${Ω}_{m} = angle \{ \frac{1}{6 ( S - 1 )} [ {\sum }_{k = 1}^{3} {\sum }_{s = 1}^{S - 1} ( \begin{matrix}{P}_{3 ( k - 1 ) + 2 , 3 ( s - 1 ) + k}^{*} {P}_{3 ( k - 1 ) + 2 , 3 s + k} + \\ {P}_{3 ( k - 1 ) + 11 , 3 ( s - 1 ) + k}^{*} {P}_{3 ( k - 1 ) + 11 , 3 s + k}\end{matrix} ) ] \}$$
where S is number of total slots in a sub-channel assigned to mobile station m, the subscript of pilot represents relative tone index within a slot and OFDM symbol index of all assigned slots respectively.

8. The method of claim 1, wherein the timing error correction is performed by rotating data symbol of an OFDM symbol by a phase that is determined by −2πk(τₘ+Δ)/N, where k is tone index of the data symbol of mobile m and N is FFT size of the OFDM system and τₘ is a low-pass filtered or averaged estimate of multiple sub-channels and frames.

9. The method of claim 1, wherein the frequency error correction is performed by rotating all data symbols of mobile m in OFDM symbol p by a phase that is determined by −2πΔfₘ((p−1)N+pN_{CP})/fₛ where fₛ is system sampling frequency and Δfₘ is a low-pass filtered or averaged estimate of multiple sub-channels and frames.

10. A method for time and frequency error correction in an access point of an OFDMA WiMAX communication system, the method comprising the step of:
detecting embedded pilot signals in mobile station data traffic after FFT and with removed Cyclic Prefix;
estimating a time error by calculating a pilot signal phase difference along a tone index within the same OFDM symbol;
estimating a frequency error by calculating a pilot signal phase difference across multiple OFDM symbols within a tone;
determining if at least one of the estimated time and frequency errors exceed a predetermined threshold; and
correcting the time and frequency errors in the access point by using a symbol rotation of transmit data.

11. The method of claim 10, wherein the WiMAX communication system is in a Adaptive Modulation and Coding implementation, and wherein the time error in the estimating a time error step is
$${τ}_{m} = \frac{N \times {Φ}_{m}}{18 π} - Δ ,$$
where
$${Φ}_{m} = angle ( \frac{1}{S} {\sum }_{s = 1}^{S} ( {P}_{11 , 1} ( s ) {P}_{2 , 1}^{*} ( s ) + {P}_{14 , 2} ( s ) {P}_{5 , 2}^{*} ( s ) + {P}_{17 , 3} ( s ) {P}_{8 , 3}^{*} ( s ) ) ) ,$$
and S is number of total slots in a sub-channel assigned to mobile station m, s is tone index, and wherein the frequency error in the estimating a frequency error step is
$$Δ {f}_{m} = \frac{{Ω}_{m}}{6 π \times {T}_{S}} ,$$
where T_{S} is OFDM symbol interval including Cyclic Prefix, and
$${Ω}_{m} = angle \{ \frac{1}{6 ( S - 1 )} [ {\sum }_{k = 1}^{3} {\sum }_{s = 1}^{S - 1} ( \begin{matrix}{P}_{3 ( k - 1 ) + 2 , 3 ( s - 1 ) + k}^{*} {P}_{3 ( k - 1 ) + 2 , 3 s + k} + \\ {P}_{3 ( k - 1 ) + 11 , 3 ( s - 1 ) + k}^{*} {P}_{3 ( k - 1 ) + 11 , 3 s + k}\end{matrix} ) ] \}$$
where S is number of total slots in a sub-channel assigned to mobile station m, the subscript of pilot represents relative tone index within a slot and OFDM symbol index of all assigned slots respectively.

12. The method of claim 11, further comprising the step of averaging Φₘ and Ωₘ over all sub-channels if the mobile station has multiple sub-channels.

13. The method of claim 10, wherein the timing error correction is performed by rotating data symbol of an OFDM symbol by a phase that is determined by −2πk(m+Δ)/N, where k is tone index of the data symbol of mobile m and N is FFT size of the OFDM system and τₘ is a low-pass filtered or averaged estimate of multiple sub-channels and frames.

14. The method of claim 10, wherein the frequency error correction is performed by rotating all data symbols of mobile m in OFDM symbol p by a phase that is determined by −2πΔfₘ((p−1)N+pN_{CP})/fₛ where fₛ is system sampling frequency and Δfₘ is a low-pass filtered or averaged estimate of multiple sub-channels and frames.

15. The method of claim 10, further comprising the steps of:
determining a least-squares channel estimate at pilot positions;
performing horizontal 1-D linear interpolation across OFDM symbols;
extrapolating at points where there is no pilot signal;
performing vertical 1-D linear interpolation across a tone index within the same OFDM symbol; and
providing a nearest fitting for remaining points.

16. The method of claim 15, wherein the least-squares channel estimate is firstly calculated at data positions where pilot symbols are present.

17. The method of claim 15, wherein horizontal 1-D linear interpolation is performed across multiple OFDM symbols within the same tone.

18. The method of claim 15, wherein extrapolation is performed at those data positions that are not covered by any pilot within the same tone.

19. The method of claim 15, wherein vertical 1-D linear interpolation is performed across all tones within the same OFDM symbol that is assigned to the same user.

20. The method of claim 15, wherein channel estimate of first tone is the same as that of second tone, across all OFDM symbols assigned to the same user.

21. The method of claim 15, wherein channel estimate of last tone is the same as that of the second tone from the last, across all OFDM symbols assigned to the same user.

22. The method of claim 10, wherein the WiMAX system in a Partial Usage of Subchannels implementation, and further comprising the steps of:
determining a least-squares channel estimate at pilot positions in a tile;
performing horizontal 1-D linear interpolation across OFDM symbols in a tile;
performing vertical 1-D linear interpolation across a tone index within the same OFDM symbol.

23. The method of claim 22, wherein the least-squares channel estimate is firstly calculated at each corner of a tile.

24. The method of claim 22, wherein the composite channel estimate of data position in the first and last tone of a tile is average of two pilots that are in the same tone, respectively.

25. The method of claim 22, wherein the composite channel estimate of data positions in a tile is given as
$${H}_{2 , n} = \frac{2}{3} {H}_{1 , n} + \frac{1}{3} {H}_{4 , n} and {H}_{3 , n} = \frac{2}{3} {H}_{4 , n} + \frac{1}{3} {H}_{1 , n} ,$$
where n denotes OFDM symbol index within the tile.

26. An access point operable to correct time and frequency errors, the access point station comprising:
a receiver operable to receive mobile station data traffic;
a processor coupled to the receiver and transmitter, the processor operable to detect embedded pilot signals in the data traffic; estimate a time error by calculating a pilot signal phase difference across a tone index within the same OFDM symbol; estimate a frequency error by calculating a pilot signal phase difference across a multiple OFDM symbols within a tone; and correct the time and frequency errors in the access point by using a symbol rotation of transmit data.
